(19) United States
(12) Patent Application Publication
(10) Pub. No.: US 2025/0361381 A1
(43) Pub. Date: Nov. 27, 2025

(54) RESIN COMPOSITION AND ARTICLE MADE THEREFROM

(71) Applicant: Elite Electronic Material (Zhongshan) Co., Ltd., Zhongshan City (CN)

(72) Inventors: Zhilong HU, Zhongshan City (CN); Changyuan LI, Zhongshan City (CN); Xiangnan LI, Zhongshan City (CN); Lianhui CAI, Zhongshan City (CN)

(21) Appl. No.: 18/775,705

(22) Filed: Jul. 17, 2024

(30) Foreign Application Priority Data
May 22, 2024 (CN) 2024106454232

(51) Int. Cl. C08K 5/50; C08J 5/24

(52) U.S. Cl. CPC C08K 5/50; C08J 5/244; C08J 2365/02

(57) ABSTRACT

A resin composition includes a vinyl group-containing polyphenylene ether resin, a vinyl group-containing crosslinking agent and a phosphorus-containing flame retardant, wherein a total amount of the vinyl group-containing polyphenylene ether resin and the vinyl group-containing crosslinking agent is 100 parts by weight, and an amount of the phosphorus-containing flame retardant is 5 parts by weight to 45 parts by weight; and the phosphorus-containing flame retardant has a structure of Formula (1). Moreover, also provided is an article made from the resin composition, including a prepreg, a resin film, a laminate, a printed circuit board or a cured insulator, and various properties can be improved including dissipation factor, inner resin flow, resin flow, flame retardancy, thermal resistance and thermal resistance after moisture absorption.

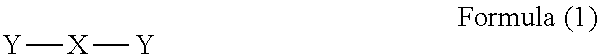

### CROSS-REFERENCE TO RELATED APPLICATION

This application claims the priority benefits of China Patent Application No. 2024106454232, filed on May 22, 2024. The entirety of the above-mentioned patent application is hereby incorporated by reference herein and made a part of this specification.

### BACKGROUND

### 1. Field of the Disclosure

The present disclosure mainly relates to a resin composition, more particularly to a resin composition useful for preparing a prepreg, a resin film, a laminate, a printed circuit board or a cured insulator.

### 2. Description of Related Art

Recently, the electronic technology has been developed towards higher density, lower power consumption and higher performance, thereby presenting more challenges to the high performance electronic materials.

With the intellectualized development of electronic products, the amount of signals that need to be processed is getting larger, and the speed is getting faster. The requirements for signal transmission loss are becoming more and more stringent. Especially for communication base stations and network communication terminals, the high-frequency and high-speed printed circuit boards (PCBs) used for these equipment rely more and more on copper-clad laminate materials to meet such property demands. Low signal transmission loss requires copper-clad laminate materials with low dissipation factor. At the same time, in order to meet the demands on reliability of the printed circuit board, the copper-clad laminate materials are also required to have better thermal resistance. Therefore, there is a need for developing materials suitable for a high performance laminate having low dissipation factor and excellent thermal resistance. In addition, while ensuring low dissipation factor and excellent thermal resistance of laminate materials, keeping the flow property of the materials in the semi-cured state at the same time is also an issue that the industry needs to address with effort.

### SUMMARY

To overcome the problems facing prior arts, particularly one or more of the above-mentioned technical problems of conventional materials, it is a primary object of the present disclosure to provide a resin composition and an article made therefrom which may overcome at least one of the above-mentioned technical problems.

To achieve the above-mentioned object, the present disclosure provides a resin composition, comprising a vinyl group-containing polyphenylene ether resin, a vinyl group-containing crosslinking agent and a phosphorus-containing flame retardant, wherein a total amount of the vinyl group-containing polyphenylene ether resin and the vinyl group-containing crosslinking agent is 100 parts by weight, an amount of the phosphorus-containing flame retardant is 5 parts by weight to 45 parts by weight, and the phosphorus-containing flame retardant has a structure of Formula (1):

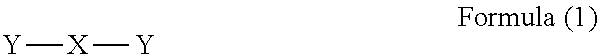

wherein, Y each independently is a diphenylphosphino group; and X is a divalent aromatic group and comprises a phenylene group, a naphthylene group, a biphenylene group or a binaphthylene group.

For example, in one embodiment, the vinyl group-containing polyphenylene ether resin comprises a vinylbenzyl group-terminated polyphenylene ether resin, a methacrylate group-terminated polyphenylene ether resin, an allyl group-terminated polyphenylene ether resin or a combination thereof.

For example, in one embodiment, the vinyl group-containing crosslinking agent comprises styrene, divinylbenzene, divinylnaphthalene, divinylbiphenyl, t-butyl styrene, bis(vinylbenzyl) ether, 1,2,4-trivinyl cyclohexane, bis(vinylphenyl) ethane, bis(vinylphenyl) hexane, bis(vinylphenyl)dimethyl ether, bis(vinylphenyl)dimethyl benzene, triallyl isocyanurate, triallyl cyanurate, diallyl bisphenol A, butadiene, decadiene, octadiene, vinylcarbazole, acrylate, styrene-divinylbenzene-ethylstyrene polymer or a combination thereof.

For example, in one embodiment, in the structure of Formula (1), X is an unsubstituted divalent aromatic group.

For example, in one embodiment, the amount of the phosphorus-containing flame retardant is 10 parts by weight to 40 parts by weight.

For example, in one embodiment, a weight ratio of the vinyl group-containing polyphenylene ether resin and the vinyl group-containing crosslinking agent is 50:50 to 80:20.

For example, in one embodiment, the resin composition further comprises an unsaturated polyolefin resin, a maleimide resin, a maleimide triazine resin, a hydrogenated unsaturated polyolefin resin, a styrene maleic anhydride resin, an epoxy resin, a phenol resin, a benzoxazine resin, a cyanate ester resin, a polyester resin, a polyamide resin, a polyimide resin or a combination thereof.

For example, in one embodiment, the resin composition further comprises amine curing agent, inorganic filler, curing accelerator, polymerization inhibitor, coloring agent, solvent, toughening agent, silane coupling agent or a combination thereof. Another main object of the present disclosure is to provide an article made from the aforesaid resin composition, comprising a prepreg, a resin film, a laminate, a printed circuit board or a cured insulator.

For example, in one embodiment, articles made from the resin composition disclosed herein have one, more or all of the following properties:
a dissipation factor at 10 GHz as measured by reference to JIS C2565 of less than or equal to 0.0042;
an inner resin flow after lamination of greater than or equal to 6 mm;
a resin flow as measured by reference to IPC-TM-650 2.3.17 of greater than or equal to 18%;
a T288 thermal resistance as measured by reference to IPC-TM-650 2.4.24.1 of greater than or equal to 45 minutes;
no delamination occurs after subjecting the article to a thermal resistance test after 1 hour of moisture absorption by reference to IPC-TM-650 2.6.16.1 and IPC-TM-650 2.4.23; and
no delamination occurs after subjecting the article to a thermal resistance test after 3 hours of moisture absorption by reference to IPC-TM-650 2.6.16.1 and IPC-TM-650 2.4.23.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

As used herein, the term “comprises,” “comprising,” “includes,” “including,” “has,” “having,” “encompasses,” “encompassing,” or any other variant thereof is construed as an open-ended transitional phrase intended to cover a non-exclusive inclusion. For example, a composition or article of manufacture that comprises a list of elements is not necessarily limited to only those elements but may include other elements not expressly listed or inherent to such composition or article of manufacture. Further, unless expressly stated to the contrary, the term “or” refers to an inclusive or and not to an exclusive or. For example, a condition “P or Q” is satisfied by any one of the following: P is true (or present) and Q is false (or not present), P is false (or not present) and Q is true (or present), and both P and Q are true (or present). In addition, whenever open-ended transitional phrases are used, such as “comprises,” “comprising,” “includes,” “including,” “encompasses,” “encompassing,” “has,” “having” or any other variant thereof, it is understood that transitional phrases such as “consisting essentially of” and “consisting of” are also disclosed and included.

In this disclosure, features or conditions presented as a numerical range or a percentage range are merely for convenience and brevity. Therefore, a numerical range or a percentage range should be interpreted as encompassing and specifically disclosing all possible subranges and individual numerals or values therein, particularly all integers therein. For example, a range of “1 to 8” should be understood as explicitly disclosing all subranges such as 1 to 7, 2 to 8, 2 to 6, 3 to 6, 4 to 8, 3 to 8 and so on, particularly all subranges defined by integers, as well as disclosing all individual values such as 1, 2, 3, 4, 5, 6, 7 and 8. Similarly, a range of “between 1 and 8” should be understood as explicitly disclosing all ranges such as 1 to 8, 1 to 7, 2 to 8, 2 to 6, 3 to 6, 4 to 8, 3 to 8 and so on and encompassing the end points of the ranges. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X1, X2 and X3,” it is intended to disclose the situations of X is X1 and X is X1 and/or X2 and/or X3. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X1, X2 and X3” and Y is described as being “selected from a group consisting of Y1, Y2 and Y3,” the disclosure includes any combination of X is X1 or X2 or X3 and Y is Y1 or Y2 or Y3. As used herein, “or a combination thereof” means “or any combination thereof”.

Unless otherwise specified, the term “resin” is a widely used common name of a synthetic polymer and is construed in the present disclosure as comprising monomer and its combination, polymer and its combination or a combination of monomer and its polymer, but not limited thereto. For example, in the present disclosure, the term “maleimide resin” is construed to encompass a maleimide monomer (a small molecule compound of maleimide), a maleimide polymer, a combination of maleimide monomers, a combination of maleimide polymers, and a combination of maleimide monomer(s) and maleimide polymer(s).

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property. In addition, as used herein, a mixture may include two or more compounds and may include a copolymer or auxiliaries, but not limited thereto.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto.

A homopolymer refers to a chemical substance formed by a single compound via polymerization, addition polymerization or condensation polymerization. A copolymer refers to a chemical substance formed by two or more compounds via polymerization, addition polymerization or condensation polymerization and may comprise: random copolymers, such as a structure of -AABABBBAAABBA-; alternating copolymers, such as a structure of -ABABABAB-; graft copolymers, such as a structure of -AA (A-BBBB) AA (A-BBBB) AAA-; and block copolymers, such as a structure of -AAAAA-BBBBBB-AAAAA-. Unless otherwise specified, according to the present disclosure, a prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured.

The term “polymer” includes but is not limited to an oligomer. An oligomer refers to a polymer with 2-20, typically 2-5, repeating units.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc. For example, such as but not limited thereto, a modification may refer to replacing a hydroxyl group with a vinyl group via a chemical reaction, or obtaining a terminal hydroxyl group from a chemical reaction of a terminal vinyl group and p-aminophenol.

Unless otherwise specified, an alkyl group, an alkenyl group and a hydrocarbyl group described herein are construed to encompass various isomers thereof. For example, a propyl group is construed to encompass n-propyl and iso-propyl.

Unless otherwise specified, as used herein, “vinyl group-containing” refers to the presence of an ethylenic carbon-carbon double bond (C═C) or a functional group derived therefrom in a compound. Therefore, examples of “vinyl group-containing” may include, but not limited to, a structure containing a vinyl group, an allyl group, a vinylbenzyl group, a methacrylate group or the like. Unless otherwise specified, the position of the aforesaid functional group is not particularly limited and may be located at the terminal of a long-chain structure. Therefore, for example, a vinyl group-containing polyphenylene ether resin represents a polyphenylene ether resin containing a vinyl group, an allyl group, a vinylbenzyl group, a methacrylate group or the like, but not limited thereto.

The unsaturated bond described herein, unless otherwise specified, refers to a reactive unsaturated bond, such as but not limited to an unsaturated double bond with the potential of being crosslinked with other functional groups, such as an unsaturated carbon-carbon double bond with the potential of being crosslinked with other functional groups, but not limited thereto.

As used herein, part(s) by weight represents weight part(s) in any weight unit, such as but not limited to kilogram, gram, pound and so on. For example, 100 parts by weight of a vinyl group-containing polyphenylene ether resin may represent 100 kilograms of the vinyl group-containing polyphenylene ether resin or 100 pounds of the vinyl group-containing polyphenylene ether resin.

The following embodiments and examples are illustrative in nature and are not intended to limit the present disclosure and its application. In addition, the present disclosure is not bound by any theory described in the background and summary above or the following embodiments or examples. Unless otherwise specified, processes, reagents and conditions described in the examples are those known in the art.

As described above, the present disclosure primarily aims to provide a resin composition comprising a vinyl group-containing polyphenylene ether resin, a vinyl group-containing crosslinking agent and a phosphorus-containing flame retardant, wherein:
a total amount of the vinyl group-containing polyphenylene ether resin and the vinyl group-containing crosslinking agent is 100 parts by weight, and an amount of the phosphorus-containing flame retardant is 5 parts by weight to 45 parts by weight; and the phosphorus-containing flame retardant has a structure of Formula (1):

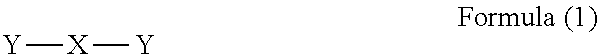

wherein, Y each independently is a diphenylphosphino group; and X is a divalent aromatic group and comprises a phenylene group, a naphthylene group, a biphenylene group or a binaphthylene group.

For example, in one embodiment, the vinyl group-containing polyphenylene ether resin used herein refers to a polyphenylene ether compound or mixture having an ethylenic carbon-carbon double bond (C═C) or a functional group derived therefrom. Examples of the ethylenic carbon-carbon double bond (C═C) or the functional group derived therefrom may include, but not limited to, a structure containing a vinyl group, a vinylene group, an allyl group, a vinylbenzyl group, a methacrylate group or the like. Unless otherwise specified, the position of the aforesaid functional group is not particularly limited and may be located at the terminal of a long-chain structure. In other words, the vinyl group-containing polyphenylene ether resin described herein represents a polyphenylene ether resin containing a reactive vinyl group or a functional group derived therefrom, examples including but not limited to a polyphenylene ether resin containing a vinyl group, a vinylene group, an allyl group, a vinylbenzyl group, or a methacrylate group.

For example, in one embodiment, the vinyl group-containing polyphenylene ether resin described herein comprises a vinylbenzyl group-terminated polyphenylene ether resin, a methacrylate group-terminated polyphenylene ether resin (i.e., methacryl group-terminated polyphenylene ether resin), an allyl group-terminated polyphenylene ether resin or a combination thereof.

For example, the vinylbenzyl group-terminated polyphenylene ether resin and the methacrylate group-terminated polyphenylene ether resin respectively comprise a structure of Formula (A-1) and a structure of Formula (A-2):

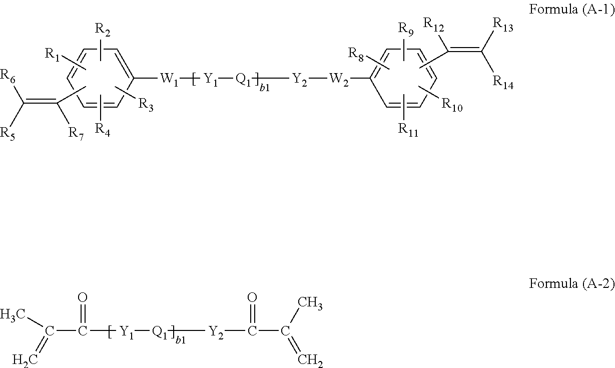

wherein R₁ to R₁₄ are individually H or —CH₃, and W₁ and W₂ are individually a C₁ to C₃ bivalent aliphatic group;
b1 is an integer of 0 to 8;
Q₁ comprises a structure of any one of Formula (B-1) to Formula (B-3) or a combination thereof:

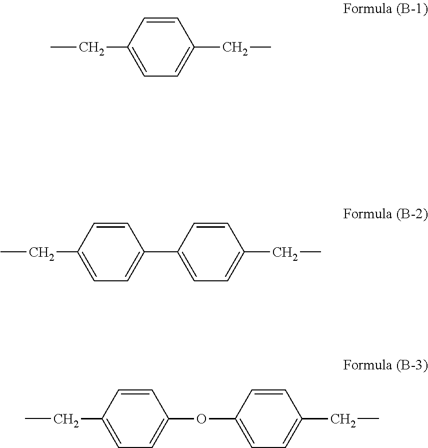

Y₁ and Y₂ independently comprise a structure of Formula (B-4):

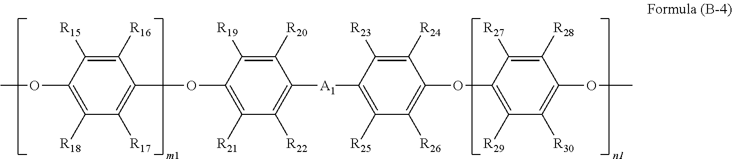

wherein R₁₅ to R₃₀ are independently H or —CH₃; m1 and n1 independently represent an integer of 1 to 30; and A₁ is selected from a covalent bond, —CH₂—, —CH(CH₃)—, —C(CH₃)₂—, —O—, —S—, -SO₂— and a carbonyl group.

For example, the vinyl group-containing polyphenylene ether resin may be a methacrylate group-containing polyphenylene ether resin (such as SA9000, available from Sabic), a vinylbenzyl group-containing polyphenylene ether resin with a number average molecular weight of about 1200 (such as OPE-2st 1200, available from Mitsubishi Gas Chemical Co., Inc.), a vinylbenzyl group-containing polyphenylene ether resin with a number average molecular weight of about 2200 (such as OPE-2st 2200, available from Mitsubishi Gas Chemical Co., Inc.), a vinylbenzyl group-modified bisphenol A polyphenylene ether resin with a number average molecular weight of about 2400 to 2800, a chain-extended vinyl group-containing polyphenylene ether resin with a number average molecular weight of about 2200 to 3000, or a combination thereof. The chain-extended vinyl group-containing polyphenylene ether resin may include various polyphenylene ether resins disclosed in the US Patent Application Publication No. 2016/0185904 A1, all of which are incorporated herein by reference in their entirety.

For example, in one embodiment, the vinyl group-containing crosslinking agent used herein refers to a compound, a polymer or a mixture containing an ethylenic carbon-carbon double bond (C═C) or a functional group derived therefrom in the molecule and being able to undergo a crosslinking reaction with a vinyl group-containing polyphenylene ether resin. In addition, the vinyl group-containing crosslinking agent is different from the aforesaid vinyl group-containing polyphenylene ether resin.

For example, the vinyl group-containing crosslinking agent refers to a vinyl group-containing compound or polymer with a molecular weight of less than or equal to 5,000, preferably between 100 and 4,000 and more preferably between 100 and 3,000. The vinyl group-containing crosslinking agent comprises but is not limited to styrene, divinylbenzene, divinylnaphthalene, divinylbiphenyl, t-butyl styrene, bis(vinylbenzyl) ether, 1,2,4-trivinylcyclohexane (TVCH), bis(vinylphenyl) ethane (BVPE), bis(vinylphenyl) hexane, bis(vinylphenyl)dimethyl ether, bis(vinylphenyl) dimethyl benzene, triallyl isocyanurate (TAIC), triallyl cyanurate (TAC), diallyl bisphenol A, butadiene, decadiene, octadiene, vinylcarbazole, acrylate, styrene-divinylbenzene-ethylstyrene polymer or a combination thereof. These components should be construed as including their isomers or polymers.

According to the present disclosure, the total amount of a vinyl group-containing polyphenylene ether resin and a vinyl group-containing crosslinking agent is 100 parts by weight, and the ratio of the two is not particularly limited. For example, in one embodiment, the amount of the vinyl group-containing polyphenylene ether resin may be 50 parts by weight, 60 parts by weight, 70 parts by weight or 80 parts by weight, and the amount of the vinyl group-containing crosslinking agent may be 20 parts by weight, 30 parts by weight, 40 parts by weight or 50 parts by weight, but not limited thereto. For example, in one embodiment, the weight ratio of the vinyl group-containing polyphenylene ether resin to the vinyl group-containing crosslinking agent may be between 50:50 and 80:20, but not limited thereto.

Relative to a total of 100 parts by weight of the vinyl group-containing polyphenylene ether resin and the vinyl group-containing crosslinking agent, the resin composition of the present disclosure further comprises 5 parts by weight to 45 parts by weight of a phosphorus-containing flame retardant of Formula (1), such as 5 parts by weight, 10 parts by weight, 15 parts by weight, 20 parts by weight, 25 parts by weight, 30 parts by weight, 35 parts by weight, 40 parts by weight or 45 parts by weight of a phosphorus-containing flame retardant, but not limited thereto.

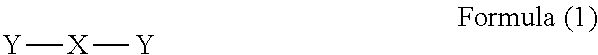

In the structure of Formula (1), Y each independently is a diphenylphosphino group, as shown in the following Formula (1-1):

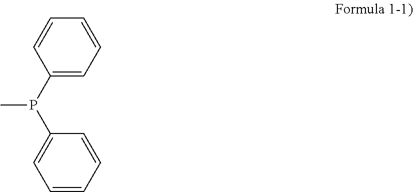

Wherein P represents a phosphorus atom and is bonded to the X group. In addition, unless otherwise specified, the diphenylphosphino group represented by the Y group may be unsubstituted, or may each independently have a substituent on the benzene ring structure, examples of the substituent comprising but not limited to monovalent alkyl, alkoxy, alkylamino, alkylthio, aryl, benzyl, aryloxy or benzyloxy group with 1 to 13 carbon atoms, such as methyl, ethyl, propyl, butyl, tert-butyl, pentyl, hexyl, heptyl, octyl, nonyl, decyl, phenyl, benzyl, methoxy, ethoxy, propoxy, butoxy, phenoxy, benzyloxy, dimethylamino, diethylamino, methylthio or ethylthio group, but not limited thereto. For example, in one embodiment, both Y groups are an unsubstituted diphenylphosphino group. For example, in another embodiment, at least one Y group is substituted by a substituent on at least one benzene ring, and the substituent may be a monovalent alkyl group with 1 to 4 carbon atoms, a monovalent alkoxy group with 1 to 4 carbon atoms, a monovalent alkylamino group with 1 to 4 carbon atoms, a phenyl group or a benzyl group.

In the structure of Formula (1), X is a divalent aromatic group and comprises a phenylene group, a naphthylene group, a biphenylene group or a binaphthylene group. For example, in one embodiment, X group is an unsubstituted divalent aromatic group. For example, in another embodiment, X group is substituted by one or more substituents, examples of the substituents comprising but not limited to a monovalent alkyl, alkoxy, alkylamino, alkylthio, aryl, benzyl, aryloxy or benzyloxy group with 1 to 13 carbon atoms, such as methyl, ethyl, propyl, butyl, tert-butyl, pentyl, hexyl, heptyl, octyl, nonyl, decyl, phenyl, benzyl, methoxy, ethoxy, propoxy, butoxy, phenoxy, benzyloxy, dimethylamino, diethylamino, methylthio or ethylthio group, but not limited thereto. In one embodiment, the substituent on the X group is a monovalent alkyl group with 1 to 4 carbon atoms, a monovalent alkoxy group with 1 to 4 carbon atoms, a monovalent alkylamino group with 1 to 4 carbon atoms, a phenyl group or a benzyl group.

For example, in one embodiment, the two diphenylphosphino groups (i.e., Y group) of the phosphorus-containing flame retardant may be located at any two substitution positions of the divalent aromatic group (i.e., X group). For example, in one embodiment, the phenylene group may be 1,2-phenylene, 1,3-phenylene or 1,4-phenylene, preferably 1,2-phenylene; the naphthylene group may be 1,2-naphthylene, 1,3-naphthylene, 1,4-naphthylene, 1,5-naphthylene, 1,6-naphthylene, 1,7-naphthylene, 1,8-naphthylene, 2,3-naphthylene, 2,6-naphthylene or 2,7-naphthylene, preferably 1,8-naphthylene; the biphenylene group may be 2,2′-biphenylene, 2,3′-biphenylene, 2,4′-biphenylene, 3,3′-biphenylene, 3,4′-biphenylene or 4,4′-biphenylene, preferably 2,2′-biphenylene; the binaphthylene group may be 2,2′-binaphthylene, 2,3′-binaphthylene or 3,3′-binaphthylene, preferably 2,2′-binaphthylene.

For example, in one embodiment, the phosphorus-containing flame retardant comprises 1,2-bis(diphenylphosphino)benzene, 2,2′-bis(diphenylphosphino) biphenyl, 1,8-bis(diphenylphosphino) naphthalene, 2,2′-bis(diphenylphosphino)-1,1′-binaphthyl or a combination thereof.

For example, in one embodiment, the phosphorus-containing flame retardant comprises any one of compounds of Formula (2) to Formula (5) or a combination thereof.

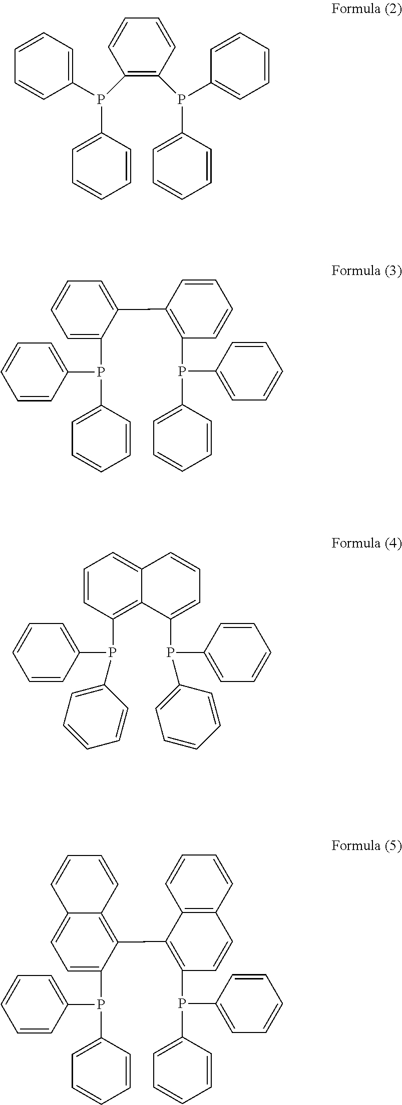 [SMILES: c1ccc(P(c2ccccc2)c2ccccc2P(c2ccccc2)c2ccccc2)cc1 ; c1ccc(P(c2ccccc2)c2ccccc2-c2ccccc2P(c2ccccc2)c2ccccc2)cc1 ; c1ccc(P(c2ccccc2)c2cccc3cccc(P(c4ccccc4)c4ccccc4)c23)cc1 ; c1ccc(P(c2ccccc2)c2ccc3ccccc3c2-c2c(P(c3ccccc3)c3ccccc3)ccc3ccccc23)cc1]

For example, in one embodiment, the resin composition may further comprise an unsaturated polyolefin resin. The unsaturated polyolefin resin may be any one or more unsaturated C═C double bond-containing polyolefin resins useful for preparing a prepreg, a resin film, a laminate, a printed circuit board or a cured insulator. The unsaturated polyolefin resin may comprise but not limited to styrene-butadiene-divinylbenzene terpolymer, ethylene-divinylbenzene-styrene polymer, maleic anhydride-adducted styrene-butadiene copolymer, maleic anhydride-adducted polybutadiene, styrene-butadiene-styrene block polymer, vinyl-polybutadiene-urethane oligomer, styrene-butadiene copolymer, styrene-isoprene copolymer, polybutadiene, ethylene propylene diene monomer, methylstyrene homopolymer, petroleum resin, cycloolefin copolymer or a combination thereof. The amount of the unsaturated polyolefin resin is not particularly limited. In one embodiment, relative to a total of 100 parts by weight of the vinyl group-containing polyphenylene ether resin and the vinyl group-containing crosslinking agent, the resin composition may comprise 5 parts by weight to 25 parts by weight of an unsaturated polyolefin resin.

Unless otherwise specified, the resin composition of the present disclosure may further optionally comprise a maleimide resin, a maleimide triazine resin, a hydrogenated unsaturated polyolefin resin, a styrene maleic anhydride resin, an epoxy resin, a phenol resin, a benzoxazine resin, a cyanate ester resin, a polyester resin, a polyamide resin, a polyimide resin or a combination thereof. In one embodiment, relative to a total of 100 parts by weight of the vinyl group-containing polyphenylene ether resin and the vinyl group-containing crosslinking agent, the amount of the aforesaid components may be 1 part by weight to 100 parts by weight, but not limited thereto.

For example, in one embodiment, the maleimide resin used herein refers to a compound or a mixture containing at least one maleimide group in the molecule. Unless otherwise specified, the maleimide resin used herein is not particularly limited and may include any one or more maleimide resins useful for preparing a prepreg, a resin film, a laminate, a printed circuit board or a cured insulator. Examples include but are not limited to 4,4′-diphenylmethane bismaleimide, oligomer of phenylmethane maleimide, biphenyl aralkyl bismaleimide, bismaleimide containing indane structure, m-phenylene bismaleimide, bisphenol A diphenyl ether bismaleimide, 3,3′-dimethyl-5,5′-diethyl-4,4′-diphenyl methane bismaleimide, 4-methyl-1,3-phenylene bismaleimide, 1,6-bismaleimide-(2,2,4-trimethyl) hexane, N-2,3-xylylmaleimide, N-2,6-xylylmaleimide, N-phenylmaleimide, maleimide resin containing aliphatic long-chain structure or a combination thereof. In addition, unless otherwise specified, the maleimide resin described herein may also comprise a prepolymer thereof, such as a prepolymer of diallyl compound and maleimide resin, a prepolymer of diamine and maleimide resin, a prepolymer of multi-functional amine and maleimide resin or a prepolymer of acid phenol compound and maleimide resin, but not limited thereto.

For example, the maleimide resin may include products such as BMI-1000, BMI-1000H, BMI-1100, BMI-1100H, BMI-2000, BMI-2300, BMI-3000, BMI-3000H, BMI-4000H, BMI-5000, BMI-5100, BM-7000 and BMI-7000H available from Daiwakasei Industry Co., Ltd., products such as BMI-70 and BMI-80 available from K.I Chemical Industry Co., Ltd, or products such as X9-470, NE-X-9470S and NE-X-9480 available from D.I.C. Corporation.

For example, the maleimide resin containing aliphatic long-chain structure may include products such as BMI-689, BMI-1400, BMI-1500, BMI-1700, BMI-2500, BMI-3000, BMI-5000 and BMI-6000 available from Designer Molecules Inc. For example, the maleimide resin containing aliphatic long chain structure may have at least one maleimide group bonded with a substituted or unsubstituted long-chain aliphatic group. The long-chain aliphatic group may be a C₅ to C₅₀ aliphatic group, such as C₁₀ to C₅₀, C₂₀ to C₅₀, C₃₀ to C₅₀, C₂₀ to C₄₀, or C₃₀ to C₄₀, but not limited thereto.

For example, in one embodiment, the maleimide triazine resin used herein is not particularly limited and may be any one or more maleimide triazine resins useful for preparing a prepreg, a resin film, a laminate, a printed circuit board or a cured insulator. For example, the maleimide triazine resin may be obtained by polymerizing a cyanate ester resin and a maleimide resin. The maleimide triazine resin may be obtained by polymerizing bisphenol A cyanate ester resin and maleimide resin, by polymerizing bisphenol F cyanate ester resin and maleimide resin, by polymerizing phenol novolac cyanate ester resin and maleimide resin or by polymerizing dicyclopentadiene-containing cyanate ester resin and maleimide resin, but not limited thereto. For example, the maleimide triazine resin may be obtained by polymerizing the cyanate ester resin and the maleimide resin at any molar ratio. For example, relative to 1 mole of the maleimide resin, 1 to 10 moles of the cyanate ester resin may be used. For example, relative to 1 mole of the maleimide resin, 1, 2, 4, or 6 moles of the cyanate ester resin may be used, but not limited thereto.

For example, in one embodiment, the hydrogenated unsaturated polyolefin resin used herein is obtained by hydrogenating an unsaturated polyolefin resin and may be any one or more hydrogenated unsaturated polyolefin resins not containing an unsaturated C═C double bond and being useful for preparing a prepreg, a resin film, a laminate, a printed circuit or a cured insulator. Examples include but are not limited to any one or a combination of hydrogenated styrene-butadiene copolymer, hydrogenated styrene-butadiene-styrene block polymer or hydrogenated styrene-isoprene copolymer.

For example, in one embodiment, the styrene maleic anhydride resin used herein may have a ratio of styrene(S) to maleic anhydride (MA) of 1:1, 2:1, 3:1, 4:1, 6:1, or 8:1, examples including but not limited to styrene maleic anhydride copolymers such as SMA-1000, SMA-2000, SMA-3000, EF-30, EF-40, EF-60 and EF-80 available from Cray Valley, or styrene maleic anhydride copolymers such as C400, C500, C700 and C900 available from Polyscope. Additionally, the styrene maleic anhydride resin may also be an esterified styrene maleic anhydride copolymer, such as esterified styrene maleic anhydride copolymers SMA1440, SMA17352, SMA2625, SMA3840 and SMA31890 available from Cray Valley. Unless otherwise specified, the styrene maleic anhydride resin can be added individually or as a combination to the resin composition of this disclosure.

For example, in one embodiment, the epoxy resin as used herein may be any epoxy resins known in the field to which this disclosure pertains, including but not limited to bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional novolac epoxy resin, dicyclopentadiene (DCPD) epoxy resin, phosphorus-containing epoxy resin, p-xylene epoxy resin, naphthalene epoxy resin (e.g., naphthol epoxy resin), benzofuran epoxy resin, isocyanate-modified epoxy resin, or a combination thereof. The novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. The phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be any one or more selected from DOPO-containing phenolic novolac epoxy resin, DOPO-containing cresol novolac epoxy resin and DOPO-containing bisphenol-A novolac epoxy resin; the DOPO-HQ epoxy resin may be any one or more selected from DOPO-HQ-containing phenolic novolac epoxy resin, DOPO-HQ-containing cresol novolac epoxy resin and DOPO-HQ-containing bisphenol-A novolac epoxy resin.

For example, in one embodiment, the phenol resin used herein may be a mono-functional, bifunctional or multi-functional phenol resin. The type of the phenol resin is not particularly limited and may include those currently used in the field to which this disclosure pertains. Preferably, the phenol resin is selected from a phenoxy resin, a novolac resin or a combination thereof.

For example, in one embodiment, the benzoxazine resin used herein may be bisphenol A benzoxazine resin, bisphenol F benzoxazine resin, phenolphthalein benzoxazine resin, dicyclopentadiene benzoxazine resin, phosphorus-containing benzoxazine resin, diamino benzoxazine resin, vinyl or allyl group-modified benzoxazine resin or a combination thereof, such as LZ-8270 (phenolphthalein benzoxazine resin), LZ-8280 (bisphenol F benzoxazine resin), and LZ-8290 (bisphenol A benzoxazine resin) available from Huntsman or HFB-2006M available from Showa High Polymer. The diamino benzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin or a combination thereof.

For example, in one embodiment, the cyanate ester resin used herein may include any known cyanate ester resins used in the art, including but not limited to a cyanate ester resin with an Ar—O—C≡N structure (wherein Ar represents an aromatic group, such as benzene, naphthalene or anthracene), a phenol novolac cyanate ester resin, a bisphenol A cyanate ester resin, a bisphenol A novolac cyanate ester resin, a bisphenol F cyanate ester resin, a bisphenol F novolac cyanate ester resin, a dicyclopentadiene-containing cyanate ester resin, a naphthalene-containing cyanate ester resin, a phenolphthalein cyanate ester resin, or a combination thereof. Examples of the cyanate ester resin include but are not limited to Primaset PT-15, PT-30S, PT-60S, BA-200, BA-230S, BA-3000S, BTP-2500, BTP-6020S, DT-4000, DT-7000, ULL950S, HTL-300, CE-320, LVT-50, or LeCy available from Lonza.

For example, in one embodiment, the polyester resin used herein may be obtained by esterification of an aromatic compound with two carboxylic groups and an aromatic compound with two hydroxyl groups, such as but not limited to HPC-8000, HPC-8150 or HPC-8200 available from D.I.C. Corporation.

For example, in one embodiment, the polyamide resin described herein may be any polyamide resins known in the field to which this disclosure pertains, including but not limited to various commercially available polyamide resin products.

For example, in one embodiment, the polyimide resin described herein may be any polyimide resins known in the field to which this disclosure pertains, including but not limited to various commercially available polyimide resin products.

For example, in one embodiment, in addition to the vinyl group-containing polyphenylene ether resin, vinyl group-containing crosslinking agent and phosphorus-containing flame retardant, the resin composition described herein further comprises amine curing agent, other flame retardant, inorganic filler, curing accelerator, polymerization inhibitor, coloring agent, solvent, toughening agent, silane coupling agent or a combination thereof.

According to the present disclosure, for example, the amine curing agent may be any amine curing agents known in the field to which this disclosure pertains. Examples include but are not limited to any one or a combination of diaminodiphenyl sulfone, diaminodiphenyl methane, diaminodiphenyl ether, diaminodiphenyl sulfide and dicyandiamide. Unless otherwise specified, in the resin composition of the present disclosure, relative to a total of 100 parts by weight of the vinyl group-containing polyphenylene ether resin and the vinyl group-containing crosslinking agent, the amount of the amine curing agent is not particularly limited, such as may be 1 part by weight to 15 parts by weight, such as but not limited to 1 part by weight, 4 parts by weight, 7.5 parts by weight, 12 parts by weight or 15 parts by weight.

For example, in one embodiment, the other flame retardant described herein is different from the phosphorus-containing flame retardant and may be any one or more flame retardants useful for preparing a prepreg, a resin film, a laminate or a printed circuit board, examples including but not limited to other phosphorus-containing flame retardant, such as any one, two or more selected from the following group: ammonium polyphosphate, hydroquinone bis-(diphenylphosphate), bisphenol A bis-(diphenylphosphate), tri (2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, DOPO and its derivatives or resins, diphenylphosphine oxide (DPPO) and its derivatives or resins, melamine cyanurate, tri-hydroxy ethyl isocyanurate, aluminium phosphinate (e.g., commercially available OP-930 and OP-935), or a combination thereof. For example, the other flame retardant used herein may be a DPPO compound (e.g., di-DPPO compound), a DOPO compound (e.g., di-DOPO compound), a DOPO resin (e.g., DOPO-HQ, DOPO-NQ, DOPO-PN, and DOPO-BPN), and a DOPO-containing epoxy resin, etc., wherein DOPO-PN is a DOPO-containing phenolic novolac compound, and DOPO-BPN may be a DOPO-containing bisphenol novolac compound, such as DOPO-BPAN (DOPO-bisphenol A novolac), DOPO-BPFN (DOPO-bisphenol F novolac) or DOPO-BPSN (DOPO-bisphenol S novolac), etc. For example, in one embodiment, relative to a total of 100 parts by weight of the vinyl group-containing polyphenylene ether resin and the vinyl group-containing crosslinking agent, the resin composition of the present disclosure may further comprise 1 part by weight to 50 parts by weight of other flame retardant, preferably 1 part by weight to 40 parts by weight of other flame retardant, but not limited thereto.

According to the present disclosure, for example, the inorganic filler may be any one or more inorganic fillers suitable for preparing a prepreg, a resin film, a laminate, a printed circuit board or a cured insulator, examples thereof including but not limited to silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride, zirconium tungstate, petalite, calcined kaolin or a combination thereof. Moreover, the inorganic filler can be spherical (including solid sphere or hollow sphere), fibrous, plate-like, particulate, flake-like or whisker-like and can be optionally pretreated by a silane coupling agent. For example, in one embodiment, relative to a total of 100 parts by weight of the vinyl group-containing polyphenylene ether resin and the vinyl group-containing crosslinking agent, the resin composition of the present disclosure may further comprise 10 parts by weight to 300 parts by weight of inorganic filler, preferably 50 parts by weight to 300 parts by weight of inorganic filler, more preferably 60 parts by weight to 280 parts by weight of inorganic filler, but not limited thereto.

According to the present disclosure, for example, the curing accelerator may comprise a catalyst, such as a Lewis base or a Lewis acid. The Lewis base may comprise any one or more of imidazole, boron trifluoride-amine complex, ethyltriphenyl phosphonium chloride, 2-methylimidazole (2 MI), 2-phenyl-1H-imidazole (2PZ), 2-ethyl-4-methylimidazole (2E4MZ), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate. The curing accelerator also includes a curing initiator, such as a peroxide capable of producing free radicals. The curing initiator comprises but is not limited to: dicumyl peroxide (DCP), t-butyl peroxybenzoate, dibenzoyl peroxide (BPO), 2,5-dimethyl-2,5-di(t-butylperoxy)-3-hexyne (25B), bis(t-butylperoxyisopropyl)benzene or a combination thereof. For example, in one embodiment, relative to a total of 100 parts by weight of the vinyl group-containing polyphenylene ether resin and the vinyl group-containing crosslinking agent, the resin composition of the present disclosure may further comprise 0.001 part by weight to 3 parts by weight of curing accelerator, preferably 0.01 part by weight to 2 parts by weight of curing accelerator, more preferably 0.2 part by weight to 1.5 parts by weight of curing accelerator, but not limited thereto.

In one embodiment, for example, the polymerization inhibitor used herein is not particularly limited and may be any polymerization inhibitor known in the field to which this disclosure pertains, including but not limited to various commercially available polymerization inhibitor products. For example, the polymerization inhibitor may comprise, but not limited to, 1,1-diphenyl-2-picrylhydrazyl radical, methyl acrylonitrile, dithioester, nitroxide-mediated radical, triphenylmethyl radical, metal ion radical, sulfur radical, hydroquinone, 4-methoxyphenol, p-benzoquinone, phenothiazine, β-phenylnaphthylamine, 4-t-butylcatechol, methylene blue, 4,4′-butylidenebis(6-t-butyl-3-methylphenol), 2,2′-methylenebis(4-ethyl-6-t-butylphenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include such as 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like. For example, in one embodiment, relative to a total of 100 parts by weight of the vinyl group-containing polyphenylene ether resin and the vinyl group-containing crosslinking agent, the resin composition of the present disclosure may further comprise 0.001 part by weight to 2 parts by weight of polymerization inhibitor.

According to the present disclosure, for example, the coloring agent may comprise but is not limited to dye or pigment. For example, in one embodiment, relative to a total of 100 parts by weight of the vinyl group-containing polyphenylene ether resin and the vinyl group-containing crosslinking agent, the resin composition of the present disclosure may further comprise 0.001 part by weight to 10 parts by weight of coloring agent, preferably 0.01 part by weight to 5 parts by weight of coloring agent, but not limited thereto.

According to the present disclosure, for example, the solvent may be any solvents suitable for dissolving the resin composition of the present disclosure, including but not limited to: methanol, ethanol, ethylene glycol monomethyl ether, acetone, butanone (methyl ethyl ketone), methyl isobutyl ketone, cyclohexanone, N-methyl-pyrrolidone, toluene, xylene, methoxyethyl acetate, ethoxyethyl acetate, propoxyethyl acetate, ethyl acetate, dimethylformamide, dimethylacetamide, propylene glycol monomethyl ether acetate, or a mixture thereof. The amount of solvent is determined in view of the purpose of completely dissolving the resin and adjusting to a certain solid content of the whole resin composition. For example, in one embodiment, the amount of solvent is added to adjust the solid content of the whole resin composition to 50%-85% (weight ratio), but not limited thereto. The solvent added to the resin composition can be evaporated and removed during the processing of the resin composition into an article such as a prepreg or a resin film, so that the insulation layer of the article such as a prepreg or resin film does not contain solvent or only contains trace amount of solvent of less than or equal to 3 wt % (i.e., 3% by weight). Therefore, the presence or absence of the solvent in the resin composition does not affect the properties of the article.

According to the present disclosure, the main purpose of adding a toughening agent is to improve the toughness of the resin composition. For example, the toughening agent suitable for the present disclosure may comprise, but not limited to, carboxyl-terminated butadiene acrylonitrile rubber (CTBN rubber), core-shell rubber, ethylene propylene rubber or a combination thereof. For example, in one embodiment, relative to a total of 100 parts by weight of the vinyl group-containing polyphenylene ether resin and the vinyl group-containing crosslinking agent, the resin composition of the present disclosure may further comprise 1 part by weight to 20 parts by weight of toughening agent, preferably 3 parts by weight to 10 parts by weight of toughening agent, but not limited thereto.

According to the present disclosure, for example, the silane coupling agent may comprise silane (such as but not limited to siloxane), which may be further categorized according to the functional groups into amino silane, epoxide silane, vinyl silane, hydroxyl silane, isocyanate silane, methacryloxy silane and acryloxy silane. For example, in one embodiment, relative to a total of 100 parts by weight of the vinyl group-containing polyphenylene ether resin and the vinyl group-containing crosslinking agent, the resin composition of the present disclosure may further comprise 0.001 part by weight to 10 parts by weight of silane coupling agent, preferably 0.01 part by weight to 5 parts by weight of silane coupling agent, but not limited thereto.

In addition to the aforesaid resin composition, the present disclosure further provides an article made from the aforesaid resin composition, such as an article suitable for use as components in electronic products, including but not limited to: a prepreg, a resin film, a laminate, a printed circuit board or a cured insulator.

For example, the resin composition of the present disclosure can be used to make a prepreg, which comprises a reinforcement material and a layered structure disposed thereon. The layered structure is formed by heating the resin composition at a high temperature to the semi-cured state (B-stage). Suitable baking temperature for making a prepreg may be for example 100° C. to 200° C., preferably 120° C. to 160° C. For example, the reinforcement material may be any one of a fiber material, woven fabric, and non-woven fabric, and the woven fabric preferably comprises fiberglass fabrics. The type of the fiberglass fabric is not particularly limited and may be any fiberglass fabrics used for a printed circuit board, such as E-glass fabric, D-glass fabric, S-glass fabric, T-glass fabric, L-glass fabric, Q-glass fabric or QL-glass fabric (glass fabric with hybrid structure made of Q-glass and L-glass). The fiber may comprise yarns and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the cured state (C-stage) to form an insulation layer.

For example, the resin composition of the disclosure can be used to make a resin film, which is prepared by heating and baking to semi-cure the resin composition. The resin composition may be selectively coated on a liquid crystal polymer film, a polytetrafluoroethylene film, a polyethylene terephthalate film (PET film), a polyimide film (PI film), a copper foil or a resin-coated copper (RCC), followed by heating and baking to semi-cure the resin composition to form the resin film.

For example, the resin composition of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 180° C. and 250° C. and preferably between 210° C. and 240° C. and a suitable curing time being 80 minutes to 180 minutes and preferably 100 minutes to 150 minutes. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a printed circuit board. In one embodiment of making the printed circuit board according to the present disclosure, a double-sided copper-clad laminate (such as product EM-827, available from Elite Electronic Material (Zhongshan) Co., Ltd.) with a thickness of 28 mil and having 1-ounce (oz) HTE (High Temperature Elongation) copper foils may be used and subject to drilling and then electroplating, so as to form electrical conduction between the top layer copper foil and the bottom layer copper foil. Then the top layer copper foil and the bottom layer copper foil are etched to form an inner layer circuit board. Then brown oxidation and roughening are performed on the inner layer circuit board to form uneven structures on the surface to increase roughness. Next, a vacuum lamination apparatus is used to laminate the assembly of a copper foil, the prepreg, the inner layer circuit board, the prepreg and a copper foil stacked in said order by heating at 180° C. to 250° C. for 80 minutes to 180 minutes to cure the insulation material of the prepregs. Next, black oxidation, drilling, copper plating and other known circuit board processes are performed on the outmost copper foils so as to obtain the printed circuit board.

For example, in one embodiment, the resin composition of the present disclosure may be further made into a cured insulator, which is obtained by curing the aforementioned resin composition through a single curing process or through multiple curing processes, wherein multiple curing processes refer to curing of greater than or equal to two times. For example, the resin composition may be semi-cured (B-stage) and then further cured to the C-stage to obtain a cured insulator. The cured insulator may include the resin composition in a cured state, the resin composition in a cured state containing reinforcement materials or a combination thereof. The preferred method of semi-curing or curing is heating, such as baking heating. In one embodiment, a suitable semi-curing temperature may be for example between 100° C. and 200° C., preferably between 120° C. and 160° C. A suitable curing temperature may be for example between 180° C. and 250° C., preferably between 210° C. and 240° C. A suitable curing time may be for example 80 minutes to 180 minutes, preferably 100 minutes to 150 minutes. The curing (C-stage) method may be further performed under pressure.

The cured insulator may include the resin composition in a cured state. In one embodiment, the present disclosure provides a preparation method for a cured insulator, including: curing the resin film. The preparation method of the cured insulator may include: coating the resin composition on a substrate (such as a polyethylene terephthalate film (PET film), a polyimide film (PI film), a copper foil or a resin-coated copper); semi-curing the resin composition to form a resin film; and curing the resin film. The preferred method of semi-curing or curing is heating, such as baking heating.

The cured insulator may include the resin composition in a cured state containing reinforcement materials. In some embodiments, the present disclosure provides a preparation method for a cured insulator, including: curing the prepreg. The preparation method of the cured insulator may include: disposing the resin composition on the reinforcement material; semi-curing the resin composition to form a prepreg containing reinforcement materials and a semi-cured layer; and curing the prepreg. The preferred method of semi-curing or curing is heating, such as baking heating.

The preparation method of the cured insulator may include molding. For example, the resin composition or the semi-cured resin composition can be placed into a mold, and the resin composition or the semi-cured resin composition can be formed and cured in the mold under a curing temperature and a certain pressure, thereby obtaining a cured insulator with a specific shape.

The cured insulator may be an insulation layer without metal on the surface obtained by removing the metal foil on the surface of the laminate or the printed circuit board.

Preferably, the resin composition of the present disclosure or the article made therefrom may achieve improvement in one or more of the following properties including dissipation factor, inner resin flow, resin flow, flame retardancy, T288 thermal resistance and PCT thermal resistance.

For example, in one embodiment, the resin composition of the present disclosure and various articles made therefrom may preferably have any one, more or all of the following properties:
a dissipation factor as measured by reference to JIS C₂₅₆₅ at 10 GHz of less than or equal to 0.0042, such as between 0.0032 and 0.0042 or between 0.0032 and 0.0040;
an inner resin flow after lamination of the article (e.g., sample for inner resin flow test) of greater than or equal to 6 mm, such as between 6 mm and 19 mm;
a resin flow as measured by reference to IPC-TM-650 2.3.17 of greater than or equal to 18%, such as between 18% and 29%;
a flame retardancy as measured by reference to UL 94 rating of V-1 or V-0, such as V-0;
a T288 thermal resistance as measured by reference to IPC-TM-650 2.4.24.1 of greater than or equal to 45 minutes, such as greater than or equal to 60 minutes, greater than or equal to 100 minutes or greater than or equal to 120 minutes, such as between 45 minutes and 150 minutes; and
no delamination occurring in a thermal resistance test after 1 hour of moisture absorption by reference to IPC-TM-650 2.6.16.1 and IPC-TM-650 2.4.23 (industrial specification requirements for a laminate or a printed circuit board), preferably no delamination occurring in a thermal resistance test after 3 hours of moisture absorption by reference to IPC-TM-650 2.6.16.1 and IPC-TM-650 2.4.23 (test conditions more stringent than the industrial specification requirements for a laminate or a printed circuit board).

Raw materials below were used to prepare the resin compositions of various Examples and Comparative Examples of the present disclosure according to the amount listed in Table 1 to Table 4 and further fabricated to prepare test samples.

Materials and reagents used in Examples and Comparative Examples disclosed herein are listed below:
SA9000: methacrylate group-terminated polyphenylene ether resin, available from Sabic.
OPE-2st 2200: vinylbenzyl group-terminated polyphenylene ether resin, available from Mitsubishi Gas Chemical Co., Inc.
TAIC: triallyl isocyanurate, available from Kingyorker Enterprise Co., Ltd.
DVB: divinylbenzene, available from Merck.
BVPE: bis(vinylphenyl) ethane, available from Linchuan Chemical Co., Ltd.
ODV: styrene-divinylbenzene-ethylstyrene polymer, available from Nippon Steel & Sumikin Chemical.
1,2-Bis(diphenylphosphino)benzene: available from Shanghai Aladdin Biochemical Technology Co., Ltd.
2,2′-Bis(diphenylphosphino) biphenyl: available from Shanghai Aladdin Biochemical Technology Co., Ltd.
2,2′-Bis(diphenylphosphino)-1,1′-binaphthyl: available from Shanghai Aladdin Biochemical Technology Co., Ltd.
1,2-Bis(diphenylphosphino) ethane: available from Shanghai Aladdin Biochemical Technology Co., Ltd.
PQ-60: p-xylylene-bis-diphenylphosphine oxide, available from Chin Yee Chemical Co., Ltd.

Di-DOPO: di-DOPO phosphorus-containing high melting point flame retardant, as shown below, synthesized by reference to Chinese Patent Application Publication CN105936745A.

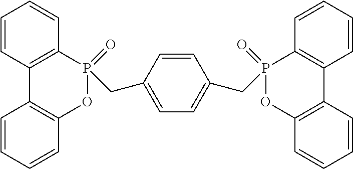 [SMILES: O=P1(Cc2ccc(CP3(=O)Oc4ccccc4-c4ccccc43)cc2)Oc2ccccc2-c2ccccc21]

1,4-Bis(diphenylphosphinyl)benzene: as shown below, available from Katayama Chemical Industries Co., Ltd.

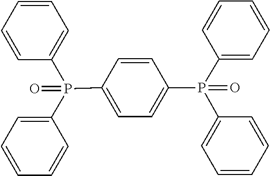 [SMILES: O=P(c1ccccc1)(c1ccccc1)c1ccc(P(=O)(c2ccccc2)c2ccccc2)cc1]

TPP: triphenylphosphine, available from Shanghai Aladdin Biochemical Technology Co., Ltd.
Ricon 100: styrene-butadiene copolymer, available from Cray Valley.
B-1000: polybutadiene, available from Nippon Soda Co., Ltd.
Ricon 184MA6: maleic anhydride-adducted styrene-butadiene copolymer, available from Cray Valley.
Ricon 257: styrene-butadiene-divinylbenzene terpolymer, available from Cray Valley. 25B: 2,5-dimethyl-2,5-di(t-butylperoxy)-3-hexyne, available from NOF Corporation.
SC-2500SMJ: spherical silica pre-treated by acrylate silane coupling agent, available from Admatechs.
Toluene: available from Chambeco Group.
Methyl ethyl ketone: MEK, commercially available, source not limited.

In the Tables, “Z” represents the total amount of components excluding (i.e., not containing) inorganic filler and solvent in the resin composition of each Example or each Comparative Example. For example, “Z*1.0” represents that the amount of inorganic filler is 1.0 time of “Z”. For example, in Example E1, “Z*1.0” represents that the amount of inorganic filler is 105.5 parts by weight (105.5 parts by weight multiplied by 1.0).

The amount of solvent is shown as “PA” in the Tables to indicate a “proper amount” to represent an amount of solvents used to achieve a desirable solid content of the whole resin composition. For a resin composition comprising methyl ethyl ketone and toluene as solvents, “PA” represents the total amount of the two solvents used to achieve a desirable solid content of the whole resin composition, such as but not limited to a solid content of 70 wt %.

In the tables, “pass” represents passing the property test, and “fail” represents failing the property test.

Compositions and test results of resin compositions of Examples and Comparative Examples used herein are listed in Table 1 to Table 4:

TABLE 1
Resin compositions of Examples (in part by weight) and test results

| Component | | E1 | E2 | E3 | E4 | E5 | E6 |
|---|---|---|---|---|---|---|---|
| vinyl group-containing | SA9000 | 70 | 70 | 70 | 70 | | 70 |
| polyphenylene ether | OPE-2st 2200 | | | | | 70 | |
| resin | | | | | | | |
| vinyl group-containing | TAIC | 30 | 30 | 30 | 30 | 30 | 30 |
| crosslinking agent | DVB | | | | | | |
| | BVPE | | | | | | |
| | ODV | | | | | | |
| phosphorus-containing | 1,2-bis(diphenyl | 5 | 10 | 40 | 45 | 40 | 40 |
| flame retardant | phosphino)benzene | | | | | | |
| | 2,2′-bis(diphenyl | | | | | | |
| | phosphino)biphenyl | | | | | | |
| | 2,2′-bis(diphenyl | | | | | | |
| | phosphino)-1,1′- | | | | | | |
| | binaphthyl | | | | | | |
| | 1,2-bis(diphenyl | | | | | | |
| | phosphino)ethane | | | | | | |
| | PQ-60 | | | | | | |
| | Di-DOPO | | | | | | |
| | 1,4-bis(diphenyl | | | | | | |
| | phosphinyl)benzene | | | | | | |
| | TPP | | | | | | |
| unsaturated polyolefin | Ricon 100 | | | | | | 5 |
| resin | B-1000 | | | | | | |
| | Ricon 184MA6 | | | | | | |
| | Ricon 257 | | | | | | |
| curing accelerator | 25B | 0.5 | 0.5 | 0.5 | 0.5 | 0.5 | 0.5 |
| inorganic filler | SC-2500SMJ | Z*1.0 | Z*1.0 | Z*1.0 | Z*1.0 | Z*1.0 | Z*1.0 |
| solvent | toluene | PA | PA | PA | PA | PA | PA |
| | MEK | PA | PA | PA | PA | PA | PA |

| Property test | Unit | E1 | E2 | E3 | E4 | E5 | E6 |
|---|---|---|---|---|---|---|---|
| Df | none | 0.0042 | 0.0040 | 0.0037 | 0.0036 | 0.0037 | 0.0038 |
| inner resin flow | mm | 8 | 11 | 17 | 18 | 16 | 13 |
| resin flow | % | 20 | 22 | 26 | 27 | 25 | 23 |
| flame retardancy | none | V-1 | V-0 | V-0 | V-0 | V-0 | V-0 |
| T288 thermal | minute | >60 | >60 | >60 | 45 | >60 | >60 |
| resistance | | | | | | | |
| PCT 1 h | none | pass | pass | pass | pass | pass | pass |
| PCT 3 h | none | pass | pass | pass | fail | pass | pass |

TABLE 2
Resin compositions of Examples (in part by weight) and test results

| Component | | E7 | E8 | E9 | E10 | E11 | E12 |
|---|---|---|---|---|---|---|---|
| vinyl group-containing | SA9000 | 70 | 70 | 70 | 70 | 70 | 70 |
| polyphenylene ether | OPE-2st 2200 | | | | | | |
| resin | | | | | | | |
| vinyl group-containing | TAIC | 30 | 30 | 30 | 30 | | |
| crosslinking agent | DVB | | | | | 30 | |
| | BVPE | | | | | | 30 |
| | ODV | | | | | | |
| phosphorus-containing | 1,2-bis(diphenyl | 40 | 40 | 40 | 40 | 40 | 40 |
| flame retardant | phosphino)benzene | | | | | | |
| | 2,2′-bis(diphenyl | | | | | | |
| | phosphino)biphenyl | | | | | | |
| | 2,2′-bis(diphenyl | | | | | | |
| | phosphino)-1,1′- | | | | | | |
| | binaphthyl | | | | | | |
| | 1,2-bis(diphenyl | | | | | | |
| | phosphino)ethane | | | | | | |
| | PQ-60 | | | | | | |
| | Di-DOPO | | | | | | |
| | 1,4-bis(diphenyl | | | | | | |
| | phosphinyl)benzene | | | | | | |
| | TPP | | | | | | |
| unsaturated polyolefin | Ricon 100 | 10 | 25 | | | | |
| resin | B-1000 | | | 10 | | | |
| | Ricon 184MA6 | | | | 5 | | |
| | Ricon 257 | | | | 5 | | |
| curing accelerator | 25B | 0.5 | 0.5 | 0.5 | 0.5 | 0.5 | 0.5 |
| inorganic filler | SC-2500SMJ | Z*1.0 | Z*1.0 | Z*1.0 | Z*1.0 | Z*1.0 | Z*1.0 |
| solvent | toluene | PA | PA | PA | PA | PA | PA |
| | MEK | PA | PA | PA | PA | PA | PA |

| Property test | Unit | E7 | E8 | E9 | E10 | E11 | E12 |
|---|---|---|---|---|---|---|---|
| Df | none | 0.0036 | 0.0034 | 0.0035 | 0.0038 | 0.0034 | 0.0033 |
| inner resin flow | mm | 17 | 19 | 18 | 16 | 12 | 18 |
| resin flow | % | 26 | 29 | 28 | 25 | 22 | 28 |
| flame retardancy | none | V-0 | V-0 | V-0 | V-0 | V-0 | V-0 |
| T288 thermal | minute | >60 | >60 | >60 | >60 | >60 | >60 |
| resistance | | | | | | | |
| PCT 1 h | none | pass | pass | pass | pass | pass | pass |
| PCT 3 h | none | pass | pass | pass | pass | pass | pass |

TABLE 3
Resin compositions of Examples (in part by weight) and test results

| Component | | E13 | E14 | E15 | E16 | E17 | E18 |
|---|---|---|---|---|---|---|---|
| vinyl group-containing | SA9000 | 70 | 70 | 70 | 40 | 40 | 45 |
| polyphenylene ether | OPE-2st 2200 | | | | 10 | 40 | 25 |
| resin | | | | | | | |
| vinyl group-containing | TAIC | | 30 | 30 | 30 | 5 | 10 |
| crosslinking agent | DVB | | | | | 5 | 5 |
| | BVPE | | | | 10 | 5 | 5 |
| | ODV | 30 | | | 10 | 5 | 10 |
| phosphorus-containing | 1,2-bis(diphenyl | 40 | | | 20 | 30 | 30 |
| flame retardant | phosphino)benzene | | | | | | |
| | 2,2′-bis(diphenyl | | 40 | | | 10 | 10 |
| | phosphino)biphenyl | | | | | | |
| | 2,2′-bis(diphenyl | | | 40 | | | |
| | phosphino)-1,1′- | | | | | | |
| | binaphthyl | | | | | | |
| | 1,2-bis(diphenyl | | | | | | |
| | phosphino)ethane | | | | | | |
| | PQ-60 | | | | | | |
| | Di-DOPO | | | | | | |
| | 1,4-bis(diphenyl | | | | | | |
| | phosphinyl)benzene | | | | | | |
| | TPP | | | | | | |
| unsaturated polyolefin | Ricon 100 | | | | | | 3 |
| resin | B-1000 | | | | | | 3 |
| | Ricon 184MA6 | | | | | | 2 |
| | Ricon 257 | | | | | | 2 |
| curing accelerator | 25B | 0.5 | 0.5 | 0.5 | 1.5 | 0.2 | 0.5 |
| inorganic filler | SC-2500SMJ | Z*1.0 | Z*1.0 | Z*1.0 | Z*0.5 | Z*2.0 | Z*1.0 |
| solvent | toluene | PA | PA | PA | PA | PA | PA |
| | MEK | PA | PA | PA | PA | PA | PA |

| Property test | Unit | E13 | E14 | E15 | E16 | E17 | E18 |
|---|---|---|---|---|---|---|---|
| Df | none | 0.0032 | 0.0037 | 0.0037 | 0.0036 | 0.0040 | 0.0038 |
| inner resin flow | mm | 10 | 16 | 6 | 10 | 11 | 16 |
| resin flow | % | 21 | 25 | 18 | 20 | 22 | 25 |
| flame retardancy | none | V-0 | V-0 | V-0 | V-0 | V-0 | V-0 |
| T288 thermal | minute | >60 | >60 | >60 | >60 | >60 | >60 |
| resistance | | | | | | | |
| PCT 1 h | none | pass | pass | pass | pass | pass | pass |
| PCT 3 h | none | pass | pass | pass | pass | pass | pass |

TABLE 4
Resin compositions of Comparative Examples (in part by weight) and test results

| Component | | C1 | C2 | C3 | C4 | C5 | C6 | C7 |
|---|---|---|---|---|---|---|---|---|
| vinyl | SA9000 | 70 | 70 | 70 | 70 | 70 | 70 | 70 |
| group-containing | OPE-2st 2200 | | | | | | | |
| polyphenylene ether | | | | | | | | |
| resin | | | | | | | | |
| vinyl | TAIC | 30 | 30 | 30 | 30 | 30 | 30 | 30 |
| group-containing | DVB | | | | | | | |
| crosslinking agent | BVPE | | | | | | | |
| | ODV | | | | | | | |
| phosphorus- | 1,2-bis(diphenyl | | | | | | 0 | 50 |
| containing flame | phosphino)benzene | | | | | | | |
| retardant | 2,2′-bis(diphenyl | | | | | | | |
| | phosphino)biphenyl | | | | | | | |
| | 2,2′-bis(diphenyl | | | | | | | |
| | phosphino)-1,1′- | | | | | | | |
| | binaphthyl | | | | | | | |
| | 1,2-bis(diphenyl | 40 | | | | | | |
| | phosphino)ethane | | | | | | | |
| | PQ-60 | | 40 | | | | | |
| | Di-DOPO | | | 40 | | | | |
| | 1,4-bis(diphenyl | | | | 40 | | | |
| | phosphinyl)benzene | | | | | | | |
| | TPP | | | | | 40 | | |
| unsaturated | Ricon 100 | | | | | | | |
| polyolefin resin | B-1000 | | | | | | | |
| | Ricon 184MA6 | | | | | | | |
| | Ricon 257 | | | | | | | |
| curing accelerator | 25B | 0.5 | 0.5 | 0.5 | 0.5 | 0.5 | 0.5 | 0.5 |
| inorganic filler | SC-2500SMJ | Z*1.0 | Z*1.0 | Z*1.0 | Z*1.0 | Z*1.0 | Z*1.0 | Z*1.0 |
| solvent | toluene | PA | PA | PA | PA | PA | PA | PA |
| | MEK | PA | PA | PA | PA | PA | PA | PA |

| Property test | Unit | C1 | C2 | C3 | C4 | C5 | C6 | C7 |
|---|---|---|---|---|---|---|---|---|
| Df | none | 0.0048 | 0.0042 | 0.0042 | 0.0042 | 0.0065 | 0.0044 | 0.0034 |
| inner resin flow | mm | 18 | 2 | 2 | 2 | >20 | 4 | 20 |
| resin flow | % | 27 | 12 | 11 | 11 | 32 | 15 | 30 |
| flame retardancy | none | V-0 | V-0 | V-0 | V-0 | V-0 | V-0 | V-0 |
| T288 thermal | minute | >60 | >60 | >60 | >60 | 1 | >60 | 15 |
| resistance | | | | | | | | |
| PCT 1 h | none | pass | pass | pass | pass | fail | pass | fail |
| PCT 3 h | none | pass | pass | pass | pass | fail | pass | fail |

Resin compositions from Table 1 to Table 4 were used to make varnishes and various samples (specimens) as described below and tested under conditions specified below so as to obtain the test results.

### Varnish

Components of the resin composition from each Example (abbreviated as E, such as E1 to E18) or Comparative Example (abbreviated as C, such as C1 to C7) were added to a stirrer according to the amounts listed in Tables 1˜4 for stirring and well-mixing to form a resin varnish.

For example, in Example E1, 70 parts by weight of a vinyl group-containing polyphenylene ether resin (SA9000), 30 parts by weight of a vinyl group-containing crosslinking agent (TAIC), 5 parts by weight of a phosphorus-containing flame retardant (1,2-bis(diphenylphosphino)benzene) were added to a stirrer containing a proper amount of toluene and a proper amount of methyl ethyl ketone (“proper amount” represents the total amount of the two solvents used to achieve a desirable solid content of the whole resin composition, such as but not limited to a resin composition having a solid content of 70 wt %), and the solution was mixed and stirred to fully dissolve the solid ingredients to form a homogeneous liquid state. Then Z*1.0 parts by weight of spherical silica SC-2500SMJ (i.e., 105.5 parts by weight) were added and well dispersed, followed by adding 0.5 part by weight of a curing accelerator (25B, pre-dissolved by a proper amount of solvent) and stirring for 1 hour to obtain the varnish of resin composition E1.

In addition, according to the components and amounts listed in Table 1 to Table 4 above, varnishes of Examples E2 to E18 and Comparative Examples C1 to C7 were prepared following the preparation process of the varnish of Example E1.

### Prepreg 1 (Using 2116 E-Glass Fiber Fabric)

Resin compositions from different Examples (E1 to E18) and Comparative Examples (C₁ to C₇) listed in Table 1 to Table 4 were respectively added to a stirred tank, well mixed and fully dissolved as varnishes and then loaded to an impregnation tank. A fiberglass fabric (e.g., 2116 E-glass fiber fabric) was passed through the impregnation tank to adhere the resin composition on the fiberglass fabric, followed by heating at 120° C. to 150° C. to the semi-cured state (B-Stage) to obtain the prepreg 1 (resin content of about 52%).

### Prepreg 2 (Using 1080 E-Glass Fiber Fabric)

Resin compositions from different Examples (E1 to E18) and Comparative Examples (C₁ to C₇) listed in Table 1 to Table 4 were respectively added to a stirred tank, well mixed and fully dissolved as varnishes and then loaded to an impregnation tank. A fiberglass fabric (e.g., 1080 E-glass fiber fabric) was passed through the impregnation tank to adhere the resin composition on the fiberglass fabric, followed by heating at 120° C. to 150° C. to the semi-cured state (B-Stage) to obtain the prepreg 2 (resin content of about 70%).

### Copper-Clad Laminate 1 (Obtained by Laminating Eight Prepregs 1)

Two 18 μm reverse treat foils (RTF copper foils) and eight prepregs 1 made from each resin composition (using 2116 E-glass fiber fabrics) were prepared batchwise. Each prepreg has a resin content of about 52%. A copper foil, eight prepregs 1 and a copper foil were superimposed in such order and then subjected to a vacuum condition for lamination at 210° C. for 2 hours to form each copper-clad laminate 1. Insulation layers were formed by curing (C-stage) eight sheets of superimposed prepreg between the two copper foils, and the resin content of the insulation layers was about 52%.

### Copper-Clad Laminate 2 (Obtained by Laminating Two Prepregs 2)

Two 18 μm reverse treat foils (RTF copper foils) and two prepregs 2 made from each resin composition (using 1080 E-glass fiber fabrics) were prepared batchwise. Each prepreg has a resin content of about 70%. A copper foil, two prepregs and a copper foil were superimposed in such order and then subjected to a vacuum condition for lamination at 210° C. for 2 hours to form each copper-clad laminate 2. Insulation layers were formed by curing (C-stage) two sheets of superimposed prepreg between the two copper foils, and the resin content of the insulation layers was about 70%.

### Copper-Free Laminate 1 (Obtained by Laminating Eight Prepregs 1)

Each copper-clad laminate 1 was etched to remove the two copper foils to obtain a copper-free laminate 1 made from laminating eight prepregs 1, and each copper-free laminate had a resin content of about 52%.

### Copper-Free Laminate 2 (Obtained by Laminating Two Prepregs 2)

Each copper-clad laminate 2 was etched to remove the two copper foils to obtain a copper-free laminate 2 made from laminating two prepregs 2, and each copper-free laminate had a resin content of about 70%.

Test items and test methods of each sample are described as below:

### 1. Dissipation Factor (Df)

In the measurement of dissipation factor, the copper-free laminate 2 sample was tested by using a microwave dielectrometer (available from AET Corp.) by reference to JIS C2565 at 10 GHz for analyzing each sample.

In the present technical field, lower dissipation factor represents better dielectric properties of the sample. Under a 10 GHz frequency, for a Df value of less than or equal to 0.005, a difference in Df of less than 0.0001 represents no substantial difference in dissipation factor in different laminates, and a difference in Df of greater than or equal to 0.0001 represents a substantial difference (i.e., significant technical difficulty) in dissipation factor in different laminates.

For example, articles made from the resin composition disclosed herein, as measured by reference to JIS C2565 at 10 GHz, have a dissipation factor of less than or equal to 0.0042, such as between 0.0032 and 0.0042 or between 0.0032 and 0.0040.

### 2. Inner Resin Flow

First, an EM-827 copper-containing laminate was used as a copper-containing core (available from Elite Electronic Material (Zhongshan) Co., Ltd., using 7628 E-glass fiber fabric and 1-ounce HTE copper foil), which had a thickness of 28 mil. Then the surface copper foil of the copper-containing core was subjected to a conventional brown oxidation process to obtain a brown oxide treated core.

A prepreg 2 prepared from each Example (E1 to E18) and each Comparative Example (C1 to C7) and a brown oxide treated core (28 mil in thickness, 18 inch*16 inch in size) were prepared, wherein the center of the prepreg 2 was a 4 inch*4 inch rhombus opening formed by using a conventional punching machine.

A piece of 0.5-ounce HTE copper foil (in reverse position, i.e., in contact with the prepreg 2 with its smooth surface), a prepreg 2 and a brown oxide treated core were superimposed in such order, followed by lamination and curing for 2 hours in vacuum at high temperature (200° C.) and high pressure (360 psi) to obtain a copper-containing multi-layer board. The surface copper foil of the copper-containing multi-layer board was removed to obtain a sample for inner resin flow test. Each side of the 4 inch*4 inch rhombus shape of the sample for inner resin flow test was divided into four equal sections by three points, and the resin flow (i.e., vertical distance of resin flow) of each of the twelve points was measured to calculate the average of resin flow at the twelve points, so as to obtain the inner resin flow (as an average, in mm) of the sample.

In the present technical field, a higher inner resin flow represents better flowability of the prepreg, and a difference in inner resin flow of greater than or equal to 1 mm represents a significant difference (i.e., significant technical difficulty). Generally, the inner resin flow is preferably between 6 mm and 20 mm. An inner resin flow of less than 6 mm represents insufficient of inner resin flow. If the prepreg is then used for build-up, it may fail to effectively fill the holes by resin flow, which may cause resin insufficiency or delamination in a circuit board.

3. Resin Flow (a.k.a. Percentage of Resin Flow, RF)

The prepreg 2 sample was punched into four 4 inch*4 inch rhombuses by using a conventional punching machine. Each sample was subjected to the measurement of resin flow (%) by reference to IPC-TM-650 2.3.17.

In the present technical field, a higher resin flow represents better flowability of the prepreg, and a difference in resin flow of greater than or equal to 1% represents a significant difference (i.e., significant technical difficulty). For example, articles made from the resin composition disclosed herein have a resin flow as measured by reference to IPC-TM-650 2.3.17 of greater than or equal to 18%, such as between 18% and 29%.

### 4. Flame Retardancy

The copper-free laminate 1 sample was subjected to the flame retardancy test. The flame retardancy test was performed in accordance with the UL 94 rating, and the results were represented by V-0, V-1, or V-2, wherein V-O indicates a superior flame retardancy to V-1, and V-1 indicates a superior flame retardancy to V-2.

For example, articles made from the resin composition disclosed herein have a flame retardancy of V-0 or V-1 as measured by reference to UL 94 rating. In addition, in some embodiments, according to the test results disclosed above, it can be confirmed that the phosphorus-containing flame retardant of the present disclosure may achieve a flame retardancy of UL 94 V-0.

### 5. T288 Thermal Resistance

The copper-clad laminate 1 sample (6.5 mm*6.5 mm in size) was used in the T288 thermal resistance test. At a constant temperature of 288° C., a thermal mechanical analyzer (TMA) was used by reference to IPC-TM-650 2.4.24.1 to test each sample and record the time to delamination (e.g., blistering) of the copper-clad laminate. Longer time to delamination represents better thermal resistance of the copper-clad laminate made from the resin composition. If no delamination was observed after 60 minutes of testing, a designation of “>60” was given.

For example, articles made from the resin composition disclosed herein are characterized by T288 thermal resistance (a time to delamination) as measured by using a thermal mechanical analyzer by reference to IPC-TM-650 2.4.24.1 of greater than or equal to 45 minutes.

6. Thermal Resistance after Moisture Absorption (PCT)

The copper-free laminate 1 sample obtained by the resin composition of each Example or Comparative Example was subjected to pressure cooking test (PCT) by reference to IPC-TM-650 2.6.16.1 for 1 hour or 3 hours of moisture absorption (testing temperature of 121° C., relative humidity of 100%), and the sample was then immersed into a 288° C. solder bath for 20 seconds, removed and then inspected to determine the absence or presence of delamination by reference to IPC-TM-650 2.4.23, such as whether interlayer delamination or blistering occurs between insulation layers. Interlayer delamination or blistering may occur between any layers of the laminate (observed by visual inspection).

For example, articles made from the resin composition disclosed herein are characterized by no delamination in a thermal resistance test after 1 hour (industrial specification requirements for a laminate or a printed circuit board) of moisture absorption by reference to IPC-TM-650 2.6.16.1 and IPC-TM-650 2.4.23. In addition, some embodiments disclosed herein may further pass the more stringent thermal resistance test after 3 hours (test conditions more stringent than industrial specification requirements for a laminate or a printed circuit board) of moisture absorption without causing delamination.

The following observations can be made from Table 1 to Table 4.

From the comparison of Examples E3 and E14-E15 and Comparative Examples C1-C5, it can be confirmed that by using a phosphorus-containing flame retardant within the scope of the present disclosure, in contrast to using a different phosphorus-containing compound, articles made from the resin composition disclosed herein may achieve at the same time one, more or all technical effects including lowering dissipation factor, increasing inner resin flow, increasing resin flow, improving T288 thermal resistance and improving PCT thermal resistance.

From the comparison of Examples E1-E4 and Comparative Examples C6-C7, it can be confirmed that by using 5 parts by weight to 45 parts by weight of a phosphorus-containing flame retardant, in contrast to using a phosphorus-containing flame retardant not within the amount range above, articles made from the resin composition disclosed herein may achieve at the same time one, more or all technical effects including lowering dissipation factor, increasing inner resin flow, increasing resin flow, improving T288 thermal resistance and improving PCT thermal resistance.

From the comparison of Examples E1-E18 and Comparative Examples C1-C7, it can be confirmed that the articles prepared by using the technical solution disclosed herein may achieve at the same time one, more or all technical effects including dissipation factor of less than or equal to 0.0042, inner resin flow of greater than or equal to 6 mm, resin flow of greater than or equal to 18%, T288 thermal resistance of greater than or equal to 45 minutes and passing thermal resistance test after 1 hour of moisture absorption. In contrast, Comparative Examples C1-C7 not using the technical solution of the present disclosure fail to achieve the aforesaid technical effects at the same time.

The above detailed description and examples are merely illustrative in nature and are not intended to limit the embodiments of the subject matter or the applications and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description can provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition comprising a vinyl group-containing polyphenylene ether resin, a vinyl group-containing crosslinking agent and a phosphorus-containing flame retardant, wherein:
a total amount of the vinyl group-containing polyphenylene ether resin and the vinyl group-containing crosslinking agent is 100 parts by weight, and an amount of the phosphorus-containing flame retardant is 5 parts by weight to 45 parts by weight; and
the phosphorus-containing flame retardant has a structure of Formula (1): 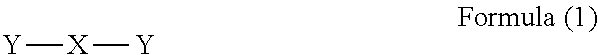
wherein, Y each independently is a diphenylphosphino group; and X is a divalent aromatic group and comprises a phenylene group, a naphthylene group, a biphenylene group or a binaphthylene group.

2. The resin composition of claim 1, wherein the vinyl group-containing polyphenylene ether resin comprises a vinylbenzyl group-terminated polyphenylene ether resin, a methacrylate group-terminated polyphenylene ether resin, an allyl group-terminated polyphenylene ether resin or a combination thereof.

3. The resin composition of claim 1, wherein the vinyl group-containing crosslinking agent comprises styrene, divinylbenzene, divinylnaphthalene, divinylbiphenyl, t-butyl styrene, bis(vinylbenzyl) ether, 1,2,4-trivinyl cyclohexane, bis(vinylphenyl) ethane, bis(vinylphenyl) hexane, bis(vinylphenyl)dimethyl ether, bis(vinylphenyl)dimethyl benzene, triallyl isocyanurate, triallyl cyanurate, diallyl bisphenol A, butadiene, decadiene, octadiene, vinylcarbazole, acrylate, styrene-divinylbenzene-ethylstyrene polymer or a combination thereof.

4. The resin composition of claim 1, wherein, in the structure of Formula (1), X is an unsubstituted divalent aromatic group.

5. The resin composition of claim 1, wherein the amount of the phosphorus-containing flame retardant is 10 parts by weight to 40 parts by weight.

6. The resin composition of claim 1, wherein a weight ratio of the vinyl group-containing polyphenylene ether resin and the vinyl group-containing crosslinking agent is 50:50 to 80:20.

7. The resin composition of claim 1, further comprising an unsaturated polyolefin resin, a maleimide resin, a maleimide triazine resin, a hydrogenated unsaturated polyolefin resin, a styrene maleic anhydride resin, an epoxy resin, a phenol resin, a benzoxazine resin, a cyanate ester resin, a polyester resin, a polyamide resin, a polyimide resin or a combination thereof.

8. The resin composition of claim 1, further comprising an amine curing agent, an inorganic filler, a curing accelerator, a polymerization inhibitor, a coloring agent, a solvent, a toughening agent, a silane coupling agent or a combination thereof.

9. An article made from the resin composition of claim 1, wherein the article comprises a prepreg, a resin film, a laminate, a printed circuit board or a cured insulator.

10. The article of claim 9, having a dissipation factor at 10 GHz as measured by reference to JIS C₂₅₆₅ of less than or equal to 0.0042.

11. The article of claim 9, having an inner resin flow after lamination of greater than or equal to 6 mm.

12. The article of claim 9, having a resin flow as measured by reference to IPC-TM-650 2.3.17 of greater than or equal to 18%.

13. The article of claim 9, having a T288 thermal resistance as measured by reference to IPC-TM-650 2.4.24.1 of greater than or equal to 45 minutes.

14. The article of claim 9, characterized in that no delamination occurs after subjecting the article to a thermal resistance test after 1 hour of moisture absorption by reference to IPC-TM-650 2.6.16.1 and IPC-TM-650 2.4.23.

15. The article of claim 9, characterized in that no delamination occurs after subjecting the article to a thermal resistance test after 3 hours of moisture absorption by reference to IPC-TM-650 2.6.16.1 and IPC-TM-650 2.4.23.
